(19) United States
(12) Patent Application Publication
(10) Pub. No.: US 2003/0146822 A1
(43) Pub. Date: Aug. 7, 2003

(54) Process for the emission of a request toward a badge

(76) Inventor: Alain Brillon, Villeneuve Tolosane (FR)

Correspondence Address: YOUNG & THOMPSON, 745 SOUTH 23RD STREET 2ND FLOOR, ARLINGTON, VA, 22202

(21) Appl. No.: 10/329,711

(22) Filed: Dec. 27, 2002

(30) Foreign Application Priority Data
Dec. 27, 2001 (FR) 0116899

(51) Int. Cl. G08C 19/00

(52) U.S. Cl. 340/10.3; 340/5.61

(57) ABSTRACT

In this process for emission of a request toward a badge of a remote control system, the request is transmitted by a signal of a predetermined frequency, with the help of antennas adapted to emit within the interior of the passenger compartment of a vehicle. The amplitude of the signal transmitting a single and same request varies in the course of the transmission of this same request between two end values (A1, A2), and in that the amplitude corresponding to the lower end value (A2) is sufficient that the portion of the request emitted with this minimum amplitude (A2) be perceived only within the predetermined zone.

The present invention relates to a process for the emission of a request toward a badge of a remote control system.

A remote control system permits giving access to a vehicle and to start the latter without having to use a mechanical key. The user of the vehicle is simply provided with a badge which is generally present in the form of an electronic card. The vehicle is provided with a control and management device associated with antennas disposed onboard. This device is adapted to detect a badge adjacent the vehicle or in the latter to then determine whether this badge is or is not an authorized badge for the corresponding vehicle. When the badge is detected and recognized as being an authorized badge for the vehicle, the bearer of the badge can enter the interior of the vehicle simply by grasping a door handle and, in certain systems, he can also start the motor of the vehicle by simple action on a button.

In most of the remote control systems, a group of antennas is adapted to detect the presence of the badge outside the vehicle and another group of antennas in the interior of the latter. These antennas emit in the direction of the badge an LF (Low Frequency) signal of a frequency typically of the order of 125 kHz. These antennas have a short range, generally of the order of one meter. It is thus possible, in a known manner, to locate a badge within or without the vehicle.

To locate a badge in the interior of the vehicle, the interior antennas emit an LF signal in the direction of the badge, this signal being the bearer of a request. When the badge located in the interior of the vehicle receives this signal, it responds to the request by sending an RF (Radio Frequency) message, typically of a frequency of 433 MHz.

To avoid detecting a badge located outside the vehicle as being a badge located in the interior of the vehicle, the emission power of the interior antennas is adjusted to a level such that, at the interior limits of the passenger compartment of the vehicle, the power of the signal corresponds substantially to the sensitivity of reception of a badge. Thus, one is certain that at any point outside the vehicle, a badge could not receive a signal emitted by the interior antennas.

This solution thus permits recognizing with certainty whether a badge which has been detected is located in the interior or on the exterior of the vehicle, but also creates masked zones within the passenger compartment. Moreover, more and more electronic equipment is located in the interior of the passenger compartment of a vehicle and emits electromagnetic signals which can interfere with the LF signals emitted by the interior antennas. If a badge is located in a region of interference, it will not detect the signal which is sent to it by the interior antennas because it will not distinguish the latter from ambient noise.

Not to detect a badge in the interior of the passenger compartment is troublesome on several levels. If the vehicle is provided with a system permitting remote control starting, the vehicle will refuse to start even though the badge is present in the interior of the vehicle. Moreover, he must now leave the badge within the vehicle when the doors of the latter are locked. Thus, if at the time of closing the doors, a badge within the vehicle does not hear the signal which is sent to it, this signal being masked by too much background noise, the doors will be locked. If thereafter the source of the background noise diminishes, the badge will be detected within the vehicle. A third party who then seeks to open the previously locked doors will receive permission to carry out this operation because of the presence of the badge forgotten within the vehicle.

The present invention thus has for its object to provide a process permitting the reliable detection of a badge within a vehicle provided with a remote control system. Preferably, the use of this process will not involve an increase in the cost of the corresponding remote control system.

To this end, the process which it provides is a process for emission of a request toward a badge of a remote control system, in which the request is transmitted by a signal of a predetermined frequency, with the aid of antennas adapted to emit within a predefined zone, such as for example the passenger compartment of a vehicle.

According to the invention, the amplitude of the signal transmitting a single and same request, varies in the course of the transmission of this same request between two end values (A1, A2), and in that the amplitude corresponding to the lower end value (A2) is sufficient that the portion of the request emitted with this minimum amplitude (A2) will be received only in the predefined zone.

In this way, a portion of the request is emitted with an amplitude such that it can be received beyond the limits of the predefined zone and another portion of this same request is emitted such that it can be received only in this zone. Hence only a badge located within the predefined zone thus receives all the request and is adapted to respond correctly to the latter.

To avoid that too great variations of the amplitude of the signal will cause the receiving badge to lose the signal, it is preferably provided that the variation of amplitude of the signal is progressive.

So as to improve the quality of the reception of the signal, at least half the request is preferably transmitted with a maximum amplitude.

In a preferred embodiment, the amplitude of the signal is greater at the beginning of the request than at the end of the request. In this case, a preferred modification provides that the amplitude of the signal is measured at the beginning of the request and that the measured amplitude is compared to the theoretical emission amplitude so as to adjust in a precise manner the amplitude of the signal at the end of the request. In this way, at the end of the request, one is assured of having for each emitted signal a same amplitude and hence a same range of the signal.

By way of numerical example, the maximum amplitude of emission is comprised preferably between 115% and 150% of the minimum amplitude of emission.

The details and advantages of the present invention will be better seen from the description which follows, given with reference to the accompanying schematic drawing, in which:

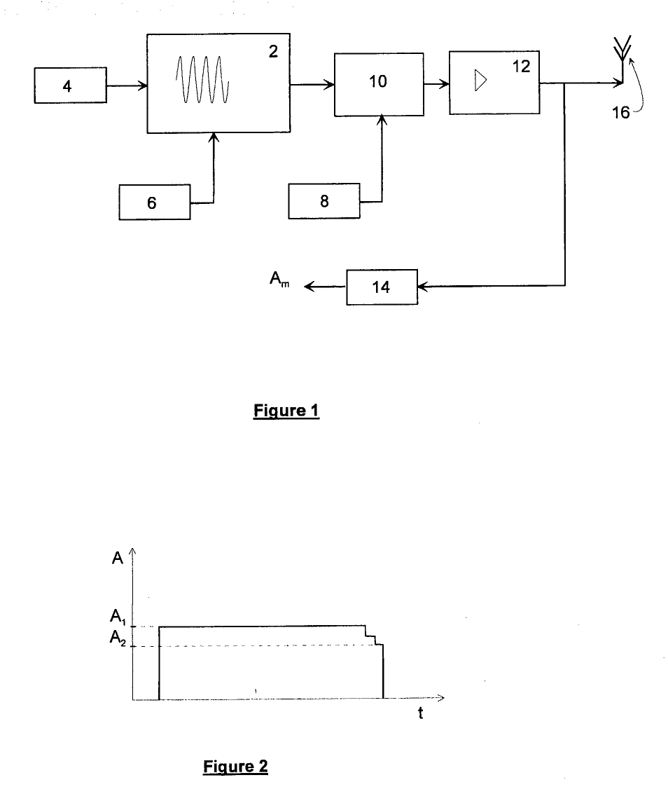

FIG. 1 shows schematically an organogram of a process according to the invention, and

FIG. 2 shows the trace of a carrier signal of a request in a process according to the invention.

The process described hereafter relates to a system of remote access and/or of starting of an automotive vehicle. The remote control access system permits a user, for access to the vehicle, to lock and unlock the doors of his vehicle without having to use a conventional mechanical key. The user simply carries a badge which is present for example in the form of an electronic card. The detection of this badge and its identification permits the locking and unlocking when the user desires and has the badge with him. Once in the vehicle, a remote control starting system permits the user carrying an authorized badge to start the vehicle by simply pressing on a button located on the dashboard.

Conventionally, a vehicle provided with a remote control system comprises a first group of antennas, called hereafter interior antennas, capable of emitting an electromagnetic signal within the interior of the passenger compartment of the vehicle. A second group of antennas, called hereafter external antennas, emits an electromagnetic signal of the same type as that emitted by the interior antennas but outside the vehicle. The electromagnetic frequency emitted by these antennas is an LF (Low Frequency) type signal which has for example a frequency of 125 kHz. The emitted signal includes a request emitted in the direction of badges adapted to receive the signal. A badge which thus recognizes the signal, responds to the request. This response is generally integrated into a signal of a frequency of 433 MHz. As a function of the response given, the badge is identified and eventually considered as an authorized badge.

To determine whether the badge is located in the interior of the passenger compartment, a signal is sent to the interior antennas, which thus carry out a corresponding emission whilst no signal is sent to the external antennas such that they remain silent. The interior antennas are generally considered as reliable. In the remote control systems of the prior art, the emission power of the interior antennas is adjusted such that the field emitted by these latter does not extend outside the passenger compartment of the vehicle. Because of this, the signals emitted have a relatively low amplitude and are sensitive to ambient noise. Moreover, the power emitted by the antennas, and hence the amplitude of the corresponding signals, can vary as a function of scattering of the emitter, as a function particularly of external parameters such as temperature.

The solution provided by the present invention consists in increasing the power emitted by the interior antennas during a portion of the emission of the signal and of the transmission of the request. A portion of the request is emitted such that it can be received only by a badge located within the zone in question, here the passenger compartment of the vehicle. A badge located outside the passenger compartment, adjacent the latter, can receive a portion of the emitted signal but as it lacks a portion of the request, it cannot respond to the latter, or in any event its response will not permit its identification. Such a process is described in greater detail hereafter with reference to the accompanying drawing.

A sinusoidal generator 2 generates a carrier of a frequency of 125 kHz. This signal is of a predetermined length and is emitted at regular time intervals. A clock 4 controls the duration of each signal as well as the interval of time separating two consecutive signals. An amplitude control device 6 acts on the amplitude of the carrier.

FIG. 2 shows schematically such a carrier. In this figure, there is shown, for a complete signal (request), the amplitude (A) of the signal as a function of time (t).

At the beginning of emission, the amplitude of the carrier has a value A1. This amplitude is kept for about 90% of the duration of emission of the complete signal. At the end of emission, the amplitude of the carrier takes a value A2, with A2<A1. The value A2 is determined such that the signal thus emitted can be received by a badge, given the sensitivity of this latter, only within the passenger compartment of the vehicle.

The passage from amplitude A1 to amplitude A2 takes place progressively. In the example shown in FIG. 2, there will be noted an intermediate plateau. A progressive decrease can also be envisaged or the presence of several plateaus. Thus, to avoid the badge losing the signal that it receives, it is necessary to avoid too great variations of amplitude of this signal.

The data 8 to be emitted are integrated into the carrier signal. These data constitute the request. The request is thus constituted by a single and same complete signal sent toward the badge. This signal comprises all the data 8 to be transmitted. The integration of the data 8 in the signal is carried out in a data modulator 10. Let it here be supposed for example that the data are distributed along the signal. It is important that a portion of the data be contained in the portion of the signal whose amplitude is A2.

The signal comprised on the one hand by the carrier and on the other hand by the data forming a request, is thus amplified in an amplifier 12 before being sent to the interior antennas 16.

In a preferred modification, an amplitude measuring device 14 measures the amplitude of the signal at the output of the amplifier 12, just before its emission by the interior antennas. The measured amplitude is called Am.

In this way, it is possible better to control the amplitude of the signal, particularly at the end of the signal. During the first phase of emission of the signal, when the amplitude has a value A1, the remote control system can compute the ratio A1_{theoretical}/A1m. A1_{theoretical} is the theoretical value that it is desired to give to the amplitude of the signal at the beginning of emission, and A1m is the value of the amplitude effectively measured at the beginning of emission. This ratio is thus introduced into the amplitude control device 6 at the end of emission of the signal. In this way, there is thus obtained always the same amplitude A2 at the end of emission. It is thus possible perfectly to control the range of emission of the interior antennas.

In the process described above, it is necessary that the amplitude at the beginning of the signal always be greater than the value A2_{theoretical}, this no matter what the derivative of the emitter. By way of numerical example, it can for example be provided that A1=1.3 A2.

The process described above permits having a detection of a badge in the interior of the passenger compartment of a vehicle which will be insensitive, or almost insensitive, to parasitical influences. Thus, to be disturbed by parasitical influences, it would be necessary that these take place only when the emitted signal is lowest. The probability of such a parasitic signal taking place just at the end of emission of the signal, becomes negligible.

It will also be noted that the above process permits a reception of the beginning of the signal with a better ratio of signal to noise than the processes of the prior art. The transmission of the signal is thus more reliable.

The present invention is not limited to the embodiment of the process described above by way of non-limiting example. It extends on the contrary to modifications of embodiment within the scope of those skilled in the art, within the scope of the following claims.

Thus, for example, the portion of the signal of least amplitude could be located not at the end of the signal but in the middle, even at the beginning of the signal.

The control of the power emitted by the antennas is as desired. This control could also be carried out in a different way. Thus, there could be provided in the passenger compartment of the vehicle a reference standardized antenna which would detect the signal emitted and would measure the real perceived magnetic field. It is thus possible to modify the amplitude of the emitted signal as a function of the magnetic field measured by the standardized antenna.

1. Process for emission of a request toward a badge of a remote control system in which the request is transmitted by a signal of a predetermined frequency, with the help of antennas adapted to emit within a predefined zone, such as for example a passenger compartment of a vehicle,
characterized in that the amplitude of the signal transmitting a single and same request varies in the course of the transmission of this same request between two end values (A1, A2), and in that the amplitude corresponding to the lower end value (A2) is sufficient that the portion of the request emitted with this minimum amplitude (A2) be perceived only in the predetermined zone.

2. Process for emission according to claim 1, characterized in that the variation of amplitude of the signal is progressive.

3. Process for emission according to one of claims 1 or 2, characterized in that at least half of the request is transmitted with a maximum amplitude (A1).

4. Process for emission according to one of claims 1 to 3, characterized in that the amplitude of the signal is greater at the beginning of the request than at the end of the request.

5. Process for emission according to claim 4, characterized in that the amplitude of the signal is measured at the beginning of the request and in that the measured amplitude (Am) is compared to the theoretical emission amplitude so as to adjust precisely the amplitude of the signal at the end of the request.

6. Process for emission according to one of claims 1 to 5, characterized in that the maximum amplitude (A1) of emission is comprised between 115% and 150% of the minimum amplitude (A2) of emission.
